(19) United States
(12) Patent Application Publication
(10) Pub. No.: US 2019/0104298 A1
(43) Pub. Date: Apr. 4, 2019

(54) METHOD FOR ADJUSTING A STEREOSCOPIC IMAGING DEVICE

(71) Applicant: STEREOLABS, ORSAY (FR)

(72) Inventors: Cécile SCHMOLLGRUBER, ORSAY (FR); Edwin, Michel AZZAM, ORSAY (FR); Olivier BRAUN, ORSAY (FR); Thomas BOURBON, ORSAY (FR)

(21) Appl. No.: 16/086,678

(22) PCT Filed: Apr. 21, 2017
(86) PCT No.: PCT/FR2017/050949

§ 371 Date: Sep. 20, 2018

(30) Foreign Application Priority Data
Apr. 26, 2016 (FR) 1653692

(51) Int. Cl. H04N 13/246; G02B 7/36; H04N 13/243

(52) U.S. Cl. CPC H04N 13/246; H04N 2013/0077; H04N 13/243; G02B 7/36

(57) ABSTRACT

“Method for adjusting a stereoscopic imaging device including for each sensor, tagging, in an image arising from the sensor, one and the same reference object, evaluating a quantity representative of a focus of the optical system associated with the sensor on the reference object, in order to adjust settings of each of the optical systems associated with a respective sensor of the stereoscopic imaging device.”

### BACKGROUND

The adjustment of the focus (also called focusing) on an imaging device such as a digital camera is essential in order to obtain a sharp image at a desired observation distance, and by extension, over the entire desired depth of field for the optical system around this desired observation distance.

The depth of field in the observed space may reach up to infinity and is the conjugation by the optical system of the depth of field in the image space. An adjusted focus corresponds to the superposition of the image plane—which is the image via the optical system of the plane of the scene for which one wishes to obtain a sharp image—with the plane of the sensor.

Techniques exist for adjusting the focus of an imaging device with a single sensor, whether before or during imaging. The most common consists of calculating the sharpness of the images or of a region of interest (ROI) of these images, generally around the center or a region chosen by the user, and maximizing this value.

However, in the case of an imaging device with several sensors, i.e., an imaging device having several image sensors and simultaneously capturing several images of the same scene from different points of view, it is necessary for the images from the various sensors to be obtained with equivalent optical and electronic settings so as next to be able to perform image processing operations.

In particular, the focusing of each detection block, made up of an optical system and a sensor, must be the same in order to guarantee that a sharp object in an image arising from one detection block is also sharp in another image done at the same time and arising from another detection block.

The fact that the detection blocks of the imaging device with several sensors have different points of view implies that the images of the same scene are different. In particular, a same object of the scene may be found in remote positions from one image to another. For this reason, the focusing operations of the detection blocks of a device with several sensors may not be adjusted using the known adjusting methods used for an imaging device with a single sensor, since the calculated metrics representative of the focusing may not be compared and each focus would then be done independently.

Focus variations between the different detection blocks would then be present and would result in making it impossible to use many image processing algorithms, for example calculating the depth of the objects in the scene (depth map) using the different points of view.

Documents US2013307938A1 and US2014160245A1 discloses a method for setting the focus for a stereoscopic imaging device, in the case at hand a camera with 2 detection blocks, using the depth of the objects in the scene as additional data. This allows them to choose an object plane to adjust the focus and to use, in the two images, only the regions that correspond to this plane, without them necessarily being in the same location in the images.

The drawback of this method is that it requires calculating the depth map of the objects of the scene. Yet this calculation is only possible if the optical and electronic settings of the detection blocks are substantially the same, and one of these settings is indeed the focus that one wishes to adjust.

It is therefore necessary to have a focus that is partially set in order for this method to work.

Additionally, a difference in quality between the lenses of the detection blocks may also create differences in sharpness between the images and prevent the use of certain image processing algorithms.

### BRIEF SUMMARY

To resolve these problems, the disclosure provided here offers a method for adjusting the focus of each detection block of an imaging device with several (at least two) sensors not requiring calculating the depth map of the scene.

The method for adjusting a stereoscopic imaging device includes, for each sensor, a step for tagging, in an image arising from the sensor, one and the same reference object, then a step for evaluating a quantity representative of the focus of the optical system associated with the sensor on the reference object, in order to adjust the settings of each of the optical systems associated with a respective sensor of the stereoscopic imaging device.

For each detection block, the method may include capturing one or several images of the same scene, before performing the tagging in the image or in a set of images arising from the same sensor, of the reference object.

The position of the reference object in the scene defines the focus plane.

The quantity representative of the focus is always calculated for one and the same object plane.

The method does not require the detection blocks to have focuses immediately already very close to their final values.

According to optional features,
the settings of each of the optical systems are adjusted in order to optimize, independently, the quantities representative of the focus;
the settings of each of the optical systems associated with a respective sensor are adjusted in order to obtain a same value for the quantities representative of the focus that are respectively associated with the optical systems.

Thus, a difference in optical quality between the two detection blocks may also be made up for by the settings, or conversely, one may seek to obtain the best of each of the optical systems.

The tagging of a reference object is done by looking for a color frame, with a predetermined shape, or specific tags.

The comparison of quantities representative of the focus calculated beforehand in order to account for the quality of the overall focus settings of the camera, i.e., the homogeneity of the focuses of all of the detection blocks as well as the quantity of the individual focus of each detection block.

A user or an automaton modifies the focus of each detection block in order to improve the focus measurements and make them homogeneous.

The process is repeated as long as the adjustment is not complete in order to update the metrics.

At the end of the adjustment, the focus is identical for each detection block of the camera. The focus is valid in the focus plane chosen via the position of the reference object, as well as over the entire depth of field in the object space of the optical systems.

The disclosure also relates to a stereoscopic imaging device, including, for each sensor, means for tagging, in an image arising from the sensor, one and the same reference object, and means for evaluating a quantity representative of the focus of the optical system associated with the sensor on the reference object, as well as means for adjusting the settings of each of the optical systems associated with a respective sensor of the stereoscopic imaging device based on representative focus quantities.

The disclosure will now be described in connection with the appended figures.

### BRIEF DESCRIPTION OF THE DRAWINGS

FIG. 1 shows alternatives of one aspect of the disclosure.

FIG. 2 shows a scene seen by an imaging device with several sensors (in this example, three sensors).

FIG. 3 shows the three images of the scene of FIG. 2 with or without implementation of the disclosure.

### DETAILED DESCRIPTION

The described method for adjusting the focus of a stereoscopic imaging device with several sensors is based on the use of a reference object. This reference object is an object whose identification and demarcation in an image can be done unambiguously in most environments. The color is generally a reliable means of performing this type of demarcation, but a specific shape or specific tags are other solutions for identifying and demarcating an object in an image.

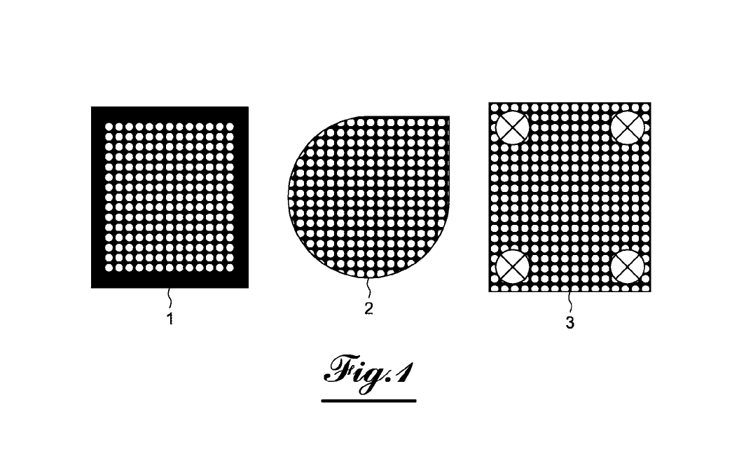

FIG. 1 provides several examples of reference objects. In all cases, the principle is the same: the reference object offers visible characteristics that allow an automatic system to identify the object in an image with a high success rate and to demarcate a region of interest in the image essentially corresponding to the object.

The reference object may have a visible colored contour 1. It may alternatively have a particular visible outer shape 2, or have specific visible tags 3.

This object is placed in an environment, images of which are captured using an imaging device with several sensors for which one wishes to adjust the focus. Here, the images are rectangular, as is often the case in imaging.

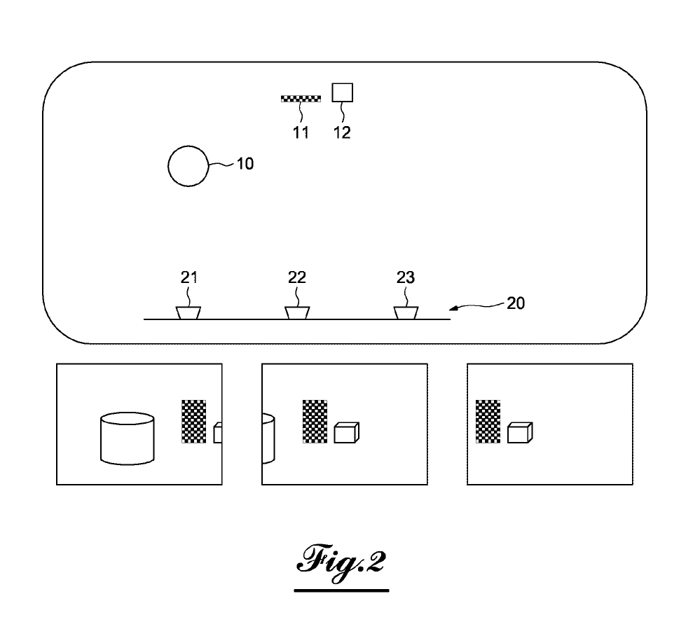

Each detection block of the imaging device captures images with a unique point of view slightly offset from those of the other blocks. One therefore obtains as many different images as there are detection blocks, as shown in FIG. 2. The scene, shown in the upper part of FIG. 2, contains three objects 10, 11, 12, one of which (referenced 11) is the reference object used to set the focus. The imaging device is referenced 20, and here includes three detection blocks 21, 22 and 23.

In the bottom part of FIG. 2 are the three images arising from the detection blocks. Each of these images has a different point of view of the scene, resulting in the difference of position of the objects in the images, visible in the figure.

These images have similarities, and in particular each image contains the reference object, but in a different position, with respect to the corners (or edges) of the image.

One then uses a detection algorithm to detect the reference object in the images.

This algorithm requires adaptation based on the type of reference object used. It may for example be an algorithm including a step by which the image is made binary based on the recognition or lack thereof of a color, point by point, then a contour detection step on the binarized image.

It may also involve an algorithm by which one looks for a contour, analyzes the shape of the contour and compares it with the expected shape of the reference object.

It may also involve an algorithm by which one looks for tags for the reference object in the image, then demarcates it in the image using the position of these tags. This type of algorithm is known in the field of image processing.

At the end of this step, one has a region of interest demarcating the reference object for each image, even if the reference object does not appear in the same position in the different images.

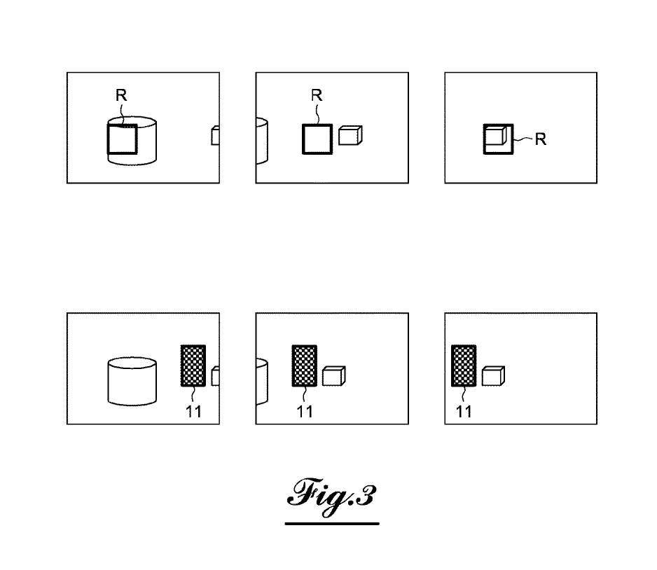

In the upper part of FIG. 3, an embodiment is shown of an imaging device not implementing the disclosure. The object 11 has been removed. No reference object is sought in the scene. The rectangle R indicates, in each image, the region where a focus adjustment is done. Since there is no reference object, these regions are for example chosen in the same location in each image, at the same distances from the corners of the image.

In the bottom part of FIG. 3, an embodiment is shown of an imaging device implementing the disclosure. The three objects appear in the images arising from the detection blocks. The rectangle indicates, in each image, the region of interest where a focus adjustment is done. Since there is a reference object in the images, the regions are located on the reference object, even if the position of the object changes in each image, with respect to the corners of the image.

Once the reference object has been identified in each image and the corresponding region of interest has been demarcated, the quantity representative of the focus is calculated. Generally, this quantity corresponds to the sharpness or blur of the considered region and is calculated using a calculating method by gradients or by spatial frequency analysis.

A sharpness quantity may be reported as a contrast quantity on the image region where the object is present.

In order to calculate this contrast, one method is to detect all of the contours in this image region and quantify them in terms of intensity. Indeed, if the object is blurry (i.e., the focus is not on the object), the detectable contours and edges of the objects present in this image region will be difficult to see or detect, or their intensity will be low.

As metric, a contour filter is therefore used, for example a Sobel filter or a Prewitt filter or indeed a Canny filter, which provides a gray level image that corresponds to the contrast of each pixel.

By obtaining the sum of the image over the image region, then dividing by the area of the image region, one obtains an average sharpness value of the image region that can be compared over the different equivalent regions of the cameras.

On a single object detected in the scene, it is possible to calculate a focus difference (without knowing how to adjust the focus of one camera relative to the other). In the case of several equivalent objects detected in the scene at different distances, the evolution of the sharpness value for each equivalent region, coupled with the distance from the identifiable object in this region, makes it possible to determine which detection block has a further or closer focus distance.

The metrics having been calculated for each image on the regions of interest demarcated by the reference object, they all correspond to a same object plane, a same depth of the scene.

One therefore has an indication of the setting of the focus to a same observation depth for each of the detection blocks.

Lastly, one analyzes all of the calculated metrics in two different ways.

A first method comprises maximizing (or minimizing, depending on the selected metric) the quantity representative of the focus in order to have the best possible settings. Here, each detection block is adjusted independently by the user or an automated or nonautomated mechanical system. This method guarantees that the adjustment of the focus will be optimal for each section block at the depth at which the reference object has been placed, as well as in the entire depth of field in the object space of the optical systems of the detection blocks.

A second method comprises comparing the calculated quantities. Indeed, the quality of the optical systems may vary slightly and introduce differences in sharpness in the image, even if each detection block is set optimally via the first method.

It is therefore necessary to perform this comparison and adjust all of the detection blocks to an equal quantity in order to obtain detection blocks with identical and compatible focus settings.

The above steps are repeated in order to update the metrics over the course of the adjustment.

The disclosure is not limited to the described embodiments, but encompasses all alternatives within the scope of the claims.

1. A method for adjusting a stereoscopic imaging device with several detection blocks, each made up of a sensor and an optical system, the method including,
for each sensor of the device, a step for tagging, in an image arising from the sensor, one and the same reference object, and
a step for evaluating a quantity representative of a focus of the optical system associated with the sensor on the reference object, in order to adjust settings of each of the optical systems associated with a respective sensor of the stereoscopic imaging device.

2. The method for adjusting a stereoscopic imaging device according to claim 1, wherein the settings of each of the optical systems are adjusted in order to optimize, independently, the quantities representative of the focus.

3. The method for adjusting a stereoscopic imaging device according to claim 1, wherein the settings of each of the optical systems associated with a respective sensor are adjusted in order to obtain a same value for the quantities representative of the focus that are respectively associated with the optical systems.

4. The method for adjusting a stereoscopic imaging device according to claim 1, wherein the tagging of a reference object is done by looking for a color frame, a predetermined shape, or specific tags.

5. The method for adjusting a stereoscopic imaging device according to claim 1, wherein the evaluation of the quantity representative of the focus includes calculating a sharpness quantity.

6. A stereoscopic imaging device with several detection blocks, each made up of a sensor and an optical system, the device including,
for each sensor, means for tagging, in an image arising from the sensor, one and the same reference object, and
means for evaluating a quantity representative of a focus of the optical system associated with the sensor on the reference object, as well as means for adjusting the settings of each of the optical systems associated with a respective sensor of the stereoscopic imaging device based on representative focus quantities.

7. The method for adjusting a stereoscopic imaging device according to claim 2, wherein the tagging of a reference object is done by looking for a color frame, a predetermined shape, or specific tags.

8. The method for adjusting a stereoscopic imaging device according to claim 3, wherein the tagging of a reference object is done by looking for a color frame, a predetermined shape, or specific tags.

9. The method for adjusting a stereoscopic imaging device according to claim 2, wherein the evaluation of the quantity representative of the focus includes calculating a sharpness quantity.

10. The method for adjusting a stereoscopic imaging device according to claim 3, wherein the evaluation of the quantity representative of the focus includes calculating a sharpness quantity.
